(19) United States
(12) Patent Application Publication
(10) Pub. No.: US 2024/0402559 A1
(43) Pub. Date: Dec. 5, 2024

(54) CIRCULARLY POLARIZED ELECTROCHROMIC DEVICE

(71) Applicant: AMBILIGHT INC, Grand Cayman (KY)

(72) Inventors: Jianguo MEI, West Lafayette, IN (US); Inho SONG, West Lafayette, IN (US)

(21) Appl. No.: 18/624,756

(22) Filed: Apr. 2, 2024

Related U.S. Application Data
(60) Provisional application No. 63/470,618, filed on Jun. 2, 2023.

(51) Int. Cl. G02F 1/157; G02F 1/1516; G02F 1/153; G02F 1/155

(52) U.S. Cl. CPC G02F 1/157; G02F 1/15165; G02F 1/1533; G02F 1/155

(57) ABSTRACT

A circularly polarized electrochromic device is disclosed. The disclosed circularly polarized electrochromic device includes a first substrate and a cell disposed on the first substrate. The cell includes a first electrode, an electrolyte layer, an ion storage layer, a second electrode and a chiral electrochromic layer that presents differential color changes and at least one of differential transmittance and differential absorbance depending upon different handedness of circularly polarized light under an applied voltage. A circularly polarized patterned electrochromic device and the corresponding preparation methods are also disclosed.

### CROSS-REFERENCE TO RELATED APPLICATIONS

This application claims benefit of and priority to U.S. Provisional Application No. 63/470,618, filed on Jun. 2, 2023, the content of which is incorporated herein in its entirety.

### TECHNICAL FIELD

The present disclosure is related to a circularly polarized electrochromic device, and more particularly, a new electrochromic device containing a chiral electrochromic layer and presenting differential color changes and at least one of differential transmittance and differential absorbance depending upon handedness of circularly polarized light under an applied voltage, and a patterned circularly polarized electrochromic device and the corresponding preparation methods.

### BACKGROUND

Manipulation of a light polarization helicity—the degree of circular polarization—with chiral matter is an attractive route toward realizing the next generation of quantum information technologies. To date, there has been rapid progress in the investigation on chiroptical interaction in diverse semiconducting materials. However, typical studies have focused on the helical light-matter interaction related to the charge or spin population of electron itself in the chiral matter. It has yet to be explored to study the dissymmetric optical activities of the semiconducting materials under electrochemical switching in consideration of lattice vibrations and their distortion by the electrons and surrounding ions in redox reactions.

The chiroptical tuning through the electrochemical switching has the potential to innovate polarization-multiplexed devices, e.g., displays, via their chiral electrochromics. These displays have recently gained attention due to the applications in various fields, including three-dimensional (3D) imaging and augmented/virtual reality systems, liquid-crystal display backlighting, high-luminance displays, bio-responsive imaging, optical control, and information encryption. Most studies on the circular polarization-modulated displays have predominantly focused on organic light-emitting diodes and liquid-crystal displays. Successful helicity modulation of light from chiral electrochromic materials with the redox reaction and a circularly polarized electrochemical device have not been demonstrated yet, which is expected to lay a foundation for the circular polarization-multiplexed, energy-saving see-through displays.

### SUMMARY

Described herein is a circularly polarized electrochromic device comprising a first substrate and a cell disposed on the first substrate, where the cell comprises a first electrode, a chiral electrochromic layer disposed on the first electrode, an electrolyte layer disposed on the chiral electrochromic layer, an ion storage layer disposed on the electrolyte layer and a second electrode disposed on the ion storage layer. Herein, the chiral electrochromic layer disposed on the first electrode presents differential color changes depending upon handedness of circularly polarized light under an applied voltage, and the chiral electrochromic layer presents at least one of differential transmittance and differential absorbance depending upon the handedness of circularly polarized light under the applied voltage.

In some embodiments, the chiral electrochromic layer comprises one or more chiral electrochromic molecules selected from a group including chiral organic electrochromic compounds, chiral electrochromic polymers and chiral electrochromic liquid crystals. In some embodiments, the chiral electrochromic layer further comprises a chiral additive besides the one or more chiral electrochromic molecules. In some embodiments, the chiral electrochromic layer comprises one or more blended systems comprising one or more molecules mixed with a chiral additive. At least one of the one or more molecules and the chiral additive is electrochromic, and the one or more molecules can be chiral or non-chiral. In some embodiments, the one or more molecules are selected from organic compounds, conjugated polymers and liquid crystals. In some embodiments, the chiral additive comprises one or more selected from a group including chiral organic compounds, chiral polymers, chiral liquid crystals, and chiral nanoparticles.

In some embodiments, the circularly polarized electrochromic device further contains a second substrate. In some embodiments, the electrolyte layer comprises a solid electrolyte, a liquid electrolyte, or a gel electrolyte. In some embodiments, at least one of the first substrate and the second substrate is flexible. In some embodiments, at least one of the first electrode and the second electrode is transparent or semi-transparent. In some embodiments, both of the first electrode and the second electrode are transparent or semi-transparent. In some embodiments, the first electrode or the second electrode comprises a reflective conducting layer. In some embodiments, the ion storage layer includes one or more oxides of metal elements in Group 4-12, or a mixture of the oxides, or one of the oxides doped by any other metal oxides or redox-active conjugated polymers or redox-active organic compounds.

The present disclosure also disclosed another circularly polarized electrochromic device. The disclosed electrochromic device comprises two substrates and a plurality of area disposed between two substrates, where each of the areas comprises a first electrode, a chiral electrochromic layer disposed on the first electrode, an electrolyte layer disposed on the chiral electrochromic layer, an ion storage layer disposed on the electrolyte layer and a second electrode disposed on the ion storage layer. Herein, the chiral electrochromic layer disposed on the first electrode presents differential color changes depending upon handedness of circularly polarized light under an applied voltage, and the chiral electrochromic layer presents at least one of differential transmittance and differential absorbance depending upon the handedness of circularly polarized light under the applied voltage.

In some embodiments, the chiral electrochromic layer comprises one or more chiral electrochromic molecules selected from a group including chiral organic electrochromic compounds, chiral electrochromic polymers and chiral electrochromic liquid crystals. In some embodiments, the chiral electrochromic layer further comprises a chiral additive besides the one or more chiral electrochromic molecules. In some embodiments, the chiral electrochromic layer comprises one or more blended systems comprising one or more molecules mixed with a chiral additive. At least one of the one or more molecules and the chiral additive is electrochromic, and the one or more molecules can be chiral or non-chiral. In some embodiments, the one or more molecules are selected from organic compounds, conjugated polymers and liquid crystals. In some embodiments, the chiral additive comprises one or more selected from a group including chiral organic compounds, chiral polymers, chiral liquid crystals, and chiral nanoparticles.

### BRIEF DESCRIPTION OF THE DRAWINGS

Certain features of various embodiments of the present technology are set forth with particularity in the appended claims. A better understanding of the features and advantages of the technology will be obtained by reference to the following detailed description that sets forth illustrative embodiments, in which the principles of the invention are utilized, and the accompanying drawings below. For the purpose of illustrating the invention, the drawings show aspects of one or more embodiments of the invention. However, it should be understood that the present invention is not limited to the precise arrangements and instrumentalities shown in the drawings.

FIG. 1 is a scheme of polarization-sensitive electrochromic (EC) image projection in transmissive display for 3D imaging, according to one embodiment.

FIG. 2 is a scheme of chiral transient templating using molecular chiral templates and long-range ordered conjugated polymers, according to some embodiments. No heat or an electric/magnetic field is needed to induce the helical ordering of achiral polymers.

FIG. 3 illustrates the optimized ellipticity spectra of the Chiral-1 film (25 wt % chiral additive, ˜350 nm) before and after thermal annealing, according to one embodiment.

FIG. 4 illustrates CIE a* and b* color coordinate values of Chiral-1 EC devices, according to one embodiment.

FIG. 5 is optical absorbance spectra of S-BN templated Chiral-1 EC devices after thermal annealing upon the left-handed circularly polarized light (LCP) and right-handed circularly polarized light (RCP), according to one embodiment.

FIG. 6 shows differential optical absorbance spectra of S-BN and R-BN templated Chiral-1 EC devices after thermal annealing, according to one embodiment.

FIGS. 7(A)-(B) are optical transmittance of S-BN (A) and R-BN (B) templated Chiral-1 EC devices upon the left-(solid line) and right-handed (broken line) circularly polarized light after thermal annealing, according to one embodiment.

FIG. 8 shows optical contrast and dynamic coloration rate of chiral templated Chiral-1 EC devices upon the left-(dense shade or circle for LCP) and right-handed (less shade or triangle for RCP) circularly polarized light, according to one embodiment.

FIG. 9 illustrates ellipticity spectra of the chiral templated Chiral-2 films (25 wt % S-Taddol additives, ˜ 200 nm) before (solid line) and after thermal annealing (dotted line), according to one embodiment.

FIG. 10 illustrates ellipticity spectra of the chiral templated Chiral-3 films (25 wt % R-BMBN additives, ˜ 200 nm) before (solid line) and after thermal annealing (dotted line), according to one embodiment.

FIG. 11 illustrates ellipticity spectra of the chiral templated Chiral-4 films (25 wt % S-BDBN additives, ˜ 200 nm) before (solid line) and after thermal annealing (dotted line), according to one embodiment.

FIG. 12 illustrates ellipticity spectra of the chiral templated Chiral-5 films (25 wt % R-DMBN additives, ˜ 200 nm) before (solid line) and after thermal annealing (dotted line), according to one embodiment.

FIG. 13 illustrates ellipticity spectra of the chiral templated Chiral-6 films (25 wt % R811 additives, ˜ 200 nm) before (solid line) and after thermal annealing (dotted line), according to one embodiment.

FIG. 14 illustrates ellipticity spectra of the chiral templated Chiral-7 films (25 wt % S-Taddol additives, ˜ 200 nm) before (solid line) and after thermal annealing (dotted line), according to one embodiment.

FIG. 15 illustrates ellipticity spectra of the chiral templated Chiral-8 films (25 wt % S-BN additives, ˜200 nm) before (solid line) and after thermal annealing (dotted line), according to one embodiment.

FIG. 16 illustrates ellipticity spectra of the chiral templated Chiral-9 films (25 wt % S-BNH additives, ˜200 nm) before (solid line) and after thermal annealing (dotted line), according to one embodiment.

FIGS. 17(A)-(C) show photographic images of chiral EC displays by patterning chiral templated EC polymer with differential handedness into grid-type square pixels, according to one embodiment. P indicates a polarization axis of linear polarizer and W indicates a fast axis of quarter waveplate. Type A incandescent, home light was used as light source for ambient condition demonstration. Scale bars indicate 2 mm in all figures. (A) shows the images measured at −45° (left) cross angles. (B) shows the images measured at 0°. (C) shows the images measured at +45° (right).

FIG. 18 shows the structures of the chiral additive BN (R-BN or S-BN) and the achiral polymer ECP-B to make Chiral-1 by a chiral templating method.

FIG. 19 shows the structures of the chiral additive S-Taddol and the chiral polymer S-ECPA to make Chiral-2 by a chiral templating method. The structure of R-Taddol is also shown.

FIG. 20 shows the structures of the chiral additive R-BMBN and the achiral polymer ECP-B to make Chiral-3 by a chiral templating method. The structure of S-BMBN is also shown.

FIG. 21 shows the structures of the chiral additive S-BDBN and the achiral polymer ECP-B to make Chiral-4 by a chiral templating method. The structure of R-BDBN is also shown.

FIG. 22 shows the structures of the chiral additive R-DMBN and the achiral polymer ECP-B to make Chiral-5 by a chiral templating method. The structure of S-DMBN is also shown.

FIG. 23 shows the structures of the chiral additive R811 and the achiral polymer ECP-B to make Chiral-6 by a chiral templating method. The structure of S811 is also shown.

FIG. 24 shows the structures of the chiral additive S-Taddol and the achiral polymer ECP-B to make Chiral-7 by a chiral templating method. The structure of R-Taddol is also shown.

FIG. 25 shows the structures of the chiral additive S-BN and the achiral polymer S-ECPA to make Chiral-8 by a chiral templating method. The structure of R-BN is also shown.

FIG. 26 shows the structures of the chiral additive R-BNH and the achiral polymer ECP-B to make Chiral-9 by a chiral templating method. The structure of S-BNH is also shown.

### DETAILED DESCRIPTION OF EMBODIMENTS

In the following description, certain specific details are set forth in order to provide a thorough understanding of various embodiments of the invention. However, one skilled in the art will understand that the invention may be practiced without these details. Moreover, while various embodiments of the invention are disclosed herein, many adaptations and modifications may be made within the scope of the invention in accordance with the common general knowledge of those skilled in this art. Such modifications include the substitution of known equivalents for any aspect of the invention in order to achieve the same result in substantially the same way.

Unless the context requires otherwise, throughout the present specification and claims, the word “comprise” and variations thereof, such as “comprises” and “comprising” are to be construed in an open, inclusive sense, that is as “including, but not limited to.” Recitation of numeric ranges of values throughout the specification is intended to serve as a shorthand notation of referring individually to each separate value falling within the range inclusive of the values defining the range, and each separate value is incorporated in the specification as it was individually recited herein. Additionally, the singular forms “a” “an”, and “the” include plural referents unless the context clearly dictates otherwise.

Reference throughout this specification to “one embodiment” or “an embodiment” means that a particular feature, structure, or characteristic described in connection with the embodiment is included in at least one embodiment of the present invention. Thus, the appearances of the phrases “in one embodiment” or “in an embodiment” in various places throughout this specification are not necessarily all referring to the same embodiment, but maybe in some instances. Furthermore, the particular features, structures, or characteristics may be combined in any suitable manner in one or more embodiments. Polarization is usually described as property of electromagnetic waves (light) which oscillate specific direction. Linear Polarization Light (LPL) can propagate horizontally, vertically, or possibly any other one direction. In detail, linearly polarized light is a confinement of the electric field vector to a given plane along the direction of propagation. Circularly Polarization Light (CPL) transmits by rotating left or right handedness. In detail, the circularly polarized light is that the electric field vector has a constant magnitude and rotating at a constant rate in a plane perpendicular to the direction of the wave. A chiral additive in the present disclosure is a chiral molecule added to the system, which can either act as a chiral dopant interacting with other molecules or just a chiral molecule physically mixed with others. For a chiral templating method, a chiral additive not only acts as a chiral dopant interacting with the polymer (e.g., by H-bonding or Van der Waals force), but also acts as a template to induce a chirality to the polymer.

The present disclosure is related to a circularly polarized electrochromic device. The device includes a first substrate and a cell disposed on the first substrate. Herein the cell comprises a first electrode, a chiral electrochromic layer disposed on the first electrode, an electrolyte layer disposed on the chiral electrochromic layer, an ion storage layer disposed on the electrolyte layer, a second electrode disposed on the ion storage layer. Herein, the chiral electrochromic layer disposed on the first electrode presents differential color changes depending upon handedness of circularly polarized light under an applied voltage, and the chiral electrochromic layer presents at least one of differential transmittance and differential absorbance depending upon handedness of circularly polarized light under the applied voltage. In some embodiments, the chiral electrochromic layer disposed on the first electrode presents differential color changes and differential transmittance depending upon handedness of circularly polarized light under an applied voltage. In some embodiments, the chiral electrochromic layer disposed on the first electrode presents differential color changes and differential absorbance depending upon handedness of circularly polarized light under an applied voltage. In some embodiments, the chiral electrochromic layer disposed on the first electrode presents differential color changes and at least one of differential transmittance and differential absorbance depending upon handedness of circularly polarized light under an applied voltage.

The present disclosure also presents a circularly polarized patterned electrochromic device. The disclosed patterned electrochromic device comprises two substrates and a plurality of area disposed between two substrates, where each of the areas comprises a first electrode, a chiral electrochromic layer disposed on the first electrode, an electrolyte layer disposed on the chiral electrochromic layer, an ion storage layer disposed on the electrolyte layer and a second electrode disposed on the ion storage layer. Herein, the chiral electrochromic layer disposed on the first electrode presents differential color changes depending upon handedness of circularly polarized light under an applied voltage, and the chiral electrochromic layer presents at least one of differential transmittance and differential absorbance depending upon handedness of circularly polarized light under the applied voltage.

In the present disclosure, chiral or nonchiral materials, for example, chiral or nonchiral polymers, form chiral electrochromic materials after interacting with a chiral additive, and the circular dichroism (CD) signal and/or differential transmittance might be increased or decreased or remained after an additional thermal annealing to remove the chiral additive.

The electrolyte for the disclosed circularly polarized electrochromic device can be solid, liquid, or gel. In some embodiments, the disclosed circularly polarized electrochromic device can have either two substrates or only one substrate. Either the first substrate or the second substrate is optional. In some embodiments, both of the first substrate and the second substrate are rigid (not flexible). In some embodiments, at least one of the first substrate and the second substrate is flexible. In some embodiments, at least one of the first electrode and the second electrode is transparent or semi-transparent. When transmittance higher than 5%, it is transparent or semi-transparent. In some embodiments, the first electrode or the second electrode comprises a reflective conducting layer. In some embodiments, both of the first electrode and the second electrode are transparent or semi-transparent. The disclosed invention can be applied to various polarization-based display devices including flexible displays when both electrodes are transparent or semi-transparent and both substrates are flexible. Any ion storage material can be used in the ion storage layer in the disclosed circularly polarized electrochromic device. In some embodiments, the ion storage layer includes one or more oxides of metal elements in Group 4-12, or a mixture of the oxides, or one of the oxides doped by any other metal oxides or redox-active conjugated polymers or redox-active organic compounds.

In some embodiments, the chiral electrochromic layer comprises one or more chiral electrochromic molecules selected from the group including chiral organic electrochromic compounds, chiral electrochromic polymers, and chiral electrochromic liquid crystals. In some embodiments, besides the one or more chiral electrochromic molecules, the chiral electrochromic layer further comprises a chiral additive. The chiral additive can be either electrochromic or non-electrochromic. In some embodiments, the chiral electrochromic layer comprises one or more blended systems comprising one or more molecules blended with a chiral additive. At least one of the one or more molecules and the chiral additive is electrochromic, and the one or more molecules can be chiral or non-chiral. In some embodiments, the one or more molecules are selected from organic compounds, conjugated polymers, and liquid crystals and the chiral additive comprises one or more selected from the group including chiral organic compounds, chiral polymers, chiral liquid crystals, and chiral nanoparticles. In some embodiments, the chiral electrochromic layer comprises a chiral electrochromic polymer. The chiral electrochromic polymer can be formed by either polymerizing a chiral monomer or oligomer or by a chiral templating method to mix a nonchiral or chiral polymer with a chiral additive to form a chiral electrochromic polymer. The chiral monomer or oligomer might have chirality in at least one of the core of the chiral monomer or oligomer, or one side chain of the chiral monomer or oligomer. For example, when the core of the chiral monomer or oligomer has chirality, it might have an axial chirality, such as Binaphthol or its similar structures. When the side chain of the chiral monomer or oligomer has chirality, it might be a thiophane with a chiral side chain, a benzene with a chiral side chain, or an acceptor with a chiral side chain (such as isoindigo with chiral side chain, diketopyrrolopyrrole with chiral side chain).

The differential color changes of the disclosed chiral electrochromic layer depending upon the different handedness of circularly polarized light might or might not be recognized by the human eye. The color can be estimated from the calculated chromaticity values L*a*b*. In some embodiments, the right-handed circularly polarized light results in a reduction of b* value and an increase in a* value for S-chiral EC films when compared to left-handed circularly polarized light exposed S-chiral EC films, while the left-handed beam results in the similar color changes for R-chiral ones. In some embodiments, the right-handed circularly polarized light results in an increase of b* value and an increase in a* value for S-chiral EC films when compared to left-handed circularly polarized light exposed S-chiral EC films, while the left-handed beam results in the similar color changes for R-chiral ones. In some embodiments, the right-handed circularly polarized light results in a reduction of a* value and an increase in b* value for S-chiral EC films when compared to left-handed circularly polarized light exposed S-chiral EC films, while the left-handed beam results in the similar color changes for R-chiral ones. In some embodiments, the right-handed circularly polarized light results in a reduction of b* value and an reduction in a* value for S-chiral EC films when compared to left-handed circularly polarized light exposed S-chiral EC films, while the left-handed beam results in the similar color changes for R-chiral ones. The color estimated from L*a*b* values demonstrates recognizable color changes visible to the human eye in chiral polymer films with different optical densities, indicating that they can be used for chiral transmissive displays utilizing optical perturbation under ambient light irradiance.

The disclosed chiral electrochromic layer can undergo a redox activity and circular dichroism changes (and/or dissymmetric transmission) simultaneously under an applied voltage. In some embodiments, in a neutral state, the disclosed chiral electrochromic layer shows a strong polarization-dependent transmittance and a color change depending on the CPL handedness. The chiral electrochromic film presents a mirror-imaged differential transmittance in a neutral state. In some embodiments, S-chiral electrochromic layer shows a larger absorbance under a left-handed circularly polarized beam while R-chiral EC devices give a larger absorbance under the right-handed circularly polarized beam. In some embodiments, S-chiral electrochromic layer shows a larger absorbance under a right-handed circularly polarized beam while R-chiral EC devices give a larger absorbance under the left-handed circularly polarized beam. In some embodiments, the CD signal of the chiral electrochromic layer might be 5 mdeg, 10 mdeg, 20 mdeg, 30 mdeg, 100 mdeg, 1000 mdeg, 5000 mdeg, 10000 mdeg, 15000 mdeg, 20000 mdeg and any values between or above.

In some embodiments, the sign of the CD can be reversed in the visible region between reduced and oxidized states. In some embodiments, in a neutral state (reduced state), the chiral electrochromic layer presents an obvious bisignate CD spectra showing one positive maximum peak and one negative maximum peak. When oxidized, the chiroptical activities of the chiral electrochromic layer gradually reduce. When highly oxidized, chiroptical activities are reversed and form a monosignate CD spectra over the visible to infrared region showing only one positive or negative maximum peak with strong bleaching in the visible region.

In some embodiments, both CD and dissymmetric transmission can be tuned by adjusting the doping level of the electrochemically active polymer helices under the applied voltage. For example, p-type (n-type) electrochromic polymers could be transparent with red-shift in absorbance spectra as they are doped under a positive (negative) voltage due to charge delocalization throughout the polymer chains. When the EC device is gradually bleached as the EC polymer is being doped with an applied voltage, the CD intensity can be attenuated. The CD signal can originate from the intrinsic exciton chirality in chiral polymer films. In the chiral exciton coupling, the intensity of the exciton CD is proportional to the square of the absorption coefficient, &, of the polymer. The absorption coefficient of the polymer decreases as the chiral polymer is oxidized, leading to the decrease in the bisignate CD intensity in the chiral films. The CD-active region is synchronized with the polymer absorbance profile, enabling a natural CD modulation through electrochemical switching of chiral electrochromic films.

In some embodiments, the color switching dynamics of EC devices can be modulated depending on the circular polarization handedness and chirality of templating molecules. In some embodiments, S-chiral EC devices show higher optical contrast under a left-handed circularly polarized beam. Therefore, S-chiral EC devices show higher coloration and bleaching efficiencies under a left-handed circularly polarized beam. R-chiral EC devices show higher optical contrast under a right-handed circularly polarized beam. R-chiral EC devices show higher coloration and bleaching efficiencies under a right-handed circularly polarized beam.

In some embodiments, the electrochemical switching time of EC devices can be modulated depending on the circular polarization handedness and chirality of templating molecules. The difference of the switching time under two different handedness of the incident beam can be 0.05, 0.1, 0.2, 0.3, 0.5, 0.7, 1.0, 1.5, 2.0, 3.0 s or any value between or more.

In some embodiments, the coloration and bleaching efficiencies of EC devices can be modulated depending on the circular polarization handedness and chirality of templating molecules. The difference of the coloration efficiencies and bleaching efficiencies under two different handedness of the incident beam can be 0.5, 1, 2, 3, 5, 10, 20, 30, 50, 70, 100, 200, 300 mC/cm² or any value between or more.

In some embodiments, the optical contrast of EC devices can be modulated depending on the circular polarization handedness and chirality of templating molecules. In some embodiments, in reduced state (colored state for display application), S-chiral EC devices show larger optical contrast under a left-handed circularly polarized beam (R-chiral EC device is reverse). In some embodiments, in reduced state (colored state for display application), S-chiral EC devices show larger optical contrast under a right-handed circularly polarized beam (R-chiral EC device is reverse). The chiral electrochromic layer shows differential optical contrast depending on the circular polarization handedness of the incident beam. The difference of the optical contrasts (4% T) under two different handedness of the incident beam can be 0.01%, 0.1%, 0.5%, 1%, 2%, 3%, 5%, 6%, 7%, 8%, 9%, 10% or any value between or more.

In some embodiments, the chiral electrochromic film demonstrates consistent differential circularly polarized transmission (dissymmetric transmittance) regardless of the rotation of the polarization axis and the viewing angle of the observer. The interaction between ambient light and the anisotropic nature of the material can give rise to artificial CD. In outdoor applications, the detrimental impact of anisotropic CD on differential transmittance can be amplified due to the interaction with versatile circular and linear polarization of random ambient light. The present disclosure demonstrates an isotropic chiroptical property irrespective of the incident light-matter interaction conditions such as azimuthal sample rotation, sample flipping, and varied beam incidence angle, leading to a wide viewing angle and a constant polarization in transmissive displays that utilize random outdoor light as a light source. This characteristic allows spectators to observe the circularly polarized transmissive image without experiencing crosstalk or a double image caused by a mismatch of the polarization axis between the display and the circular polarization filter, as well as incorrect positioning of the observer.

The disclosed circularly polarized electrochromic device provides differential color changes and at least one of differential transmittance and differential absorbance depending on the handedness of circularly polarization under an applied voltage. In some embodiments, under ambient light conditions, the chiral EC films allow a noticeable color perturbation in the human eye, functioning as a chiral transmissive display. This paves the way for the highly promising application of these newly developed homochiral EC systems in 3D imaging, information encryption, electronic polarized displays, and next-generation smart windows.

By selectively patterning chiral EC films using standard photolithography techniques, a circular polarization-encoded EC display can be created. In some embodiments, to read the encoded circularly polarized transmission, a quarter waveplate and linear polarizer are placed between the chiral EC display and a digital camera. These components act as a circular polarization filter, selectively blocking one-handedness circularly polarized light depending on the cross angle between the lenses. By rotating the cross angle, an observable image change is achieved after passing through the circular polarization filter. This approach may be used for polarization-encoded 3D display with circular polarization filtered glasses (FIG. 1). The EC films transmit two different handedness of CPL from the normal (ambient) light. In some embodiments, R-chiral films transmit more RCP. S-chiral films transmit more LCP. In some embodiments, R-chiral films transmit more LCP. S-chiral films transmit more RCP. Using bare eyes, the inventors cannot discriminate two differential handedness of CPL, so the inventors see just no pattern using bare eyes. Through special CPL filter lens, the inventors can see two different images of S-chiral and R-chiral films. For example, the left figures are seen through LCP (left handed CPL) lens (it means all RCP is blocked and only LCP can transmit the filter). Then, the inventors can see only S-chiral films show clear color. But when the inventors use different CPL lens (right images), then they show reverse data. Consequently, the two images from a single segment display can be separated to enter the left and right human eyes after passing through opposite circular polarization lenses, resulting in binocular disparity and an immersive 3D sensation for viewers. Furthermore, the circular polarization-encoded images can be hidden from native eye as demonstrated through using linear polarization filtering (i.e., zero cross angle between waveplate and linear polarizer), which showcase a successful proof-of-concept for information encryption and anti-counterfeit concepts using circular polarization encoding.

In the following detailed embodiments, chiral electrochromic polymers are used as example chiral electrochromic materials to construct and present the disclosed circularly polarized electrochromic device. Other chiral electrochromic material disclosed in this application can be used to make the disclosed circularly polarized electrochromic device and have similar characteristics as the examples given below. The chiral electrochromic polymer can be formed by either polymerizing a chiral monomer or oligomer or by a chiral templating method to mix a nonchiral or chiral polymer with a chiral additive to form a chiral electrochromic polymer. In the following detailed embodiments, a novel chiral templating method is mainly used as an example to form a chiral electrochromic polymer.

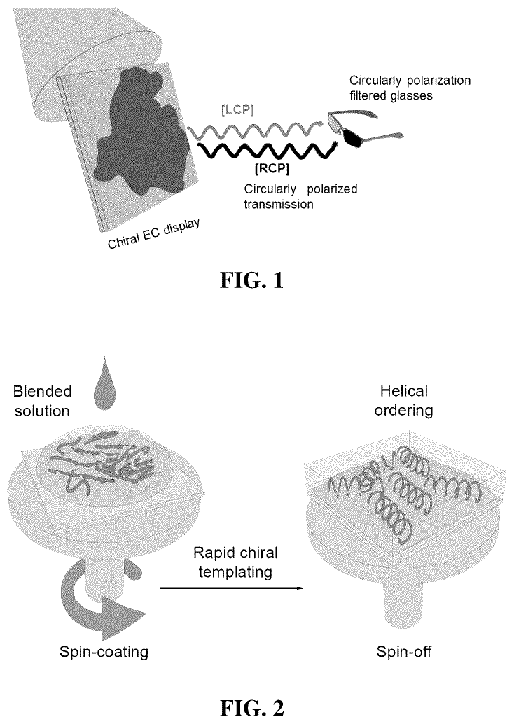

A chiral templating method is to mix chiral additives into an electrochromic polymer to assist the formation of the dissymmetric active layer. A detailed scheme for the chiral templating method is shown in FIG. 2. In some embodiments, the mixing ratio of chiral additives in the system can range between, for example, 1% to 80% wt. An electrochromic polymer is blended with a chiral dopant in a solvent to form a blended solution. In the solution, the chiral dopant and the polymer interact with each other weakly. With spin-coating, rapid chiral templating happens when the solvent is dried. The interaction between the polymer and the chiral dopant becomes strong in the thin film and the polymer presents helical ordering with chirality. The chiral nature of polymer assemblies is induced by rapid helix formation through a rapid solidification process in solution coating without extra high-energy heat or electric/magnetic field. In some embodiments, the interaction between the chiral additives and achiral polymers are strong and the electrochromic polymer can have strong chiral stacking with a chiral dopant in a spin coating process. With an additional thermal annealing, chiral templates can be selectively removed due to the low boiling point of the chiral templates, and the helicity of the chiral electrochromic layer can be not significantly attenuated. In some embodiments, after forming the chiral electrochromic layer, with an additional thermal annealing, the chirality of the chiral electrochromic layer might be further enhanced. In some embodiments, after forming the chiral electrochromic layer, the chirality of the chiral electrochromic layer might be decreased or lost when an additional thermal annealing is applied, thus, an additional thermal annealing should be avoided for such cases. A chiral templating method can also be used by mixing chiral additives (dopants) into chiral electrochromic polymers. The chiral additives can interact with a chiral electrochromic polymer and influence the chirality depending on whether the chirality of the chiral additive matches with the one of the chiral electrochromic polymer. When the chirality matches, the chirality might be enhanced, while when the chirality does not match, the chirality might be reversed or reduced or even lost. When the chirality is lost, it cannot be used for the disclosed electrochromic device/display (ECD).

### EMBODIMENTS

### Embodiment 1—Chiral-1

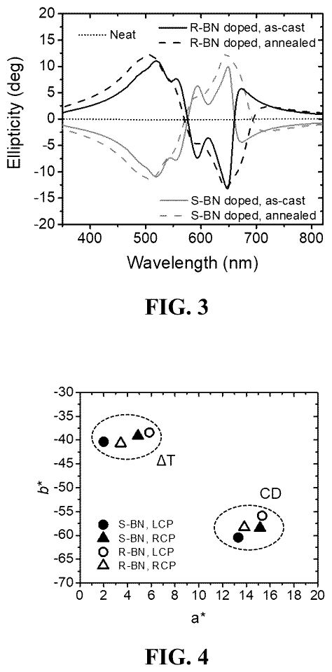

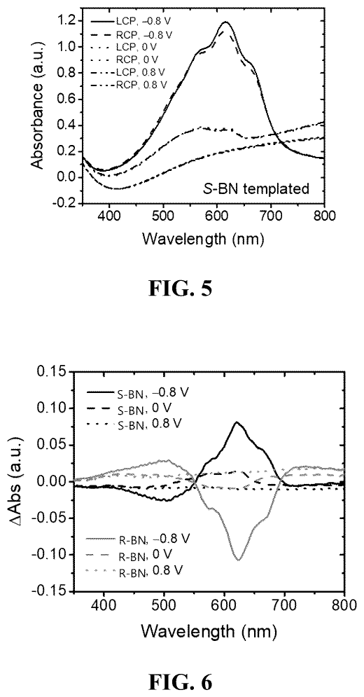

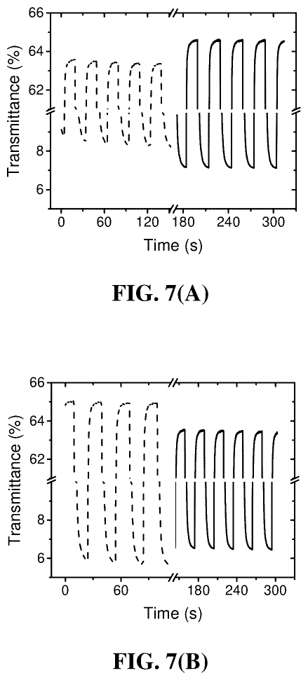

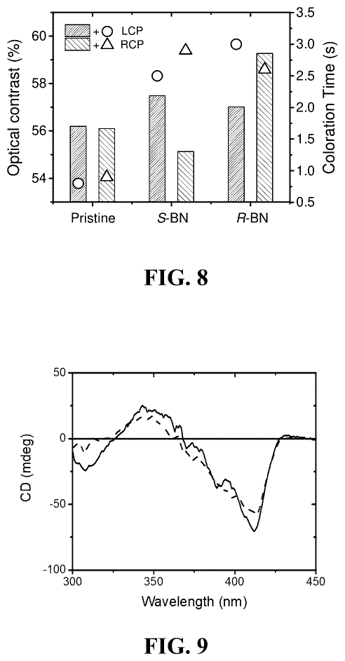

Chiral-1 is prepared by a chiral templating method by mixing the chiral additive BN (R-BN, S-BN) and the achiral polymer ECP-B shown in FIG. 18 (mixing ratio ranges from 20% to 35%). In the cyclic voltammetry measurements, the pristine (achiral) and chiral films show almost identical curve shapes, peak positions, and oxidation onsets, which indicate that they possess a similar electrochemical reaction. As shown in FIG. 3, Chiral-1 (S-BN doped or R-BN doped) is highly dissymmetric with a high CD signal in the neutral state with optimized thicker films before and after annealing. The CD signals are either retained or enhanced after thermal annealing. The intrinsic chiroptical behavior allows a significant polarization-dependent transmittance and a natural color change depending on the CP handedness. The differential color changes of Chiral-1 ECD, as shown in FIG. 4, illustrates that the right-handed circularly polarized light results in a reduction of b* value and an increase in a* value for S-BN templated EC films while the left-handed beam results in the similar color changes for R-BN templated ones. This indicates that the pure blue hues of the Chiral-1 EC films are attenuated when circular polarization handedness and chirality of transmissive matter are not matched. As shown in FIG. 5, S-templated Chiral-1 EC devices show a larger absorbance under the left-handed circularly polarized beam in the neutral state, while R-templated Chiral-1 EC devices give a larger absorbance under the right-handed beam (not shown). By applying the potential from −0.8V to 0 V to 0.8V, the Chiral-1 EC devices are gradually bleached as the EC polymer is being doped, as shown in FIG. 6, the obvious bisignate CD spectra are simultaneously gradually attenuated, finally leading to a reversible inversion of the sign of the Cottom effect. A larger transmittance contrast (4% T) of around 3% depending on the circular polarization handedness of the incident beam, as shown in FIG. 7(A)-(B). The coloration rates of the chiral templated films are also changed by the incidence of different handedness of the circularly polarized beam (FIG. 8). It is found that the optical switching becomes faster when the EC optical contrast increases.

### Embodiment 2—Chiral-2

Chiral-2 is prepared by a chiral templating method by mixing the chiral additive S-Taddol and the chiral polymer S-ECPA shown in FIG. 19. S-ECPA has a small CD signal of about 10 mdeg without the chiral additive. As shown in FIG. 19, after the interaction with S-taddol, the CD signal for Chiral-2 is amplified to around 70 mdeg in the neutral state and decreases slightly after thermal annealing at 250° C. R-Taddol can also be used as a chiral template with S-ECPA.

### Embodiment 3—Chiral-3

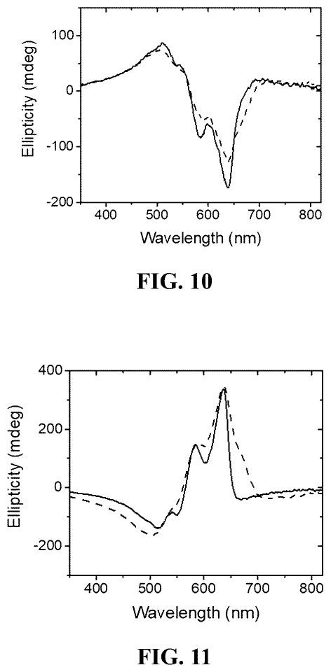

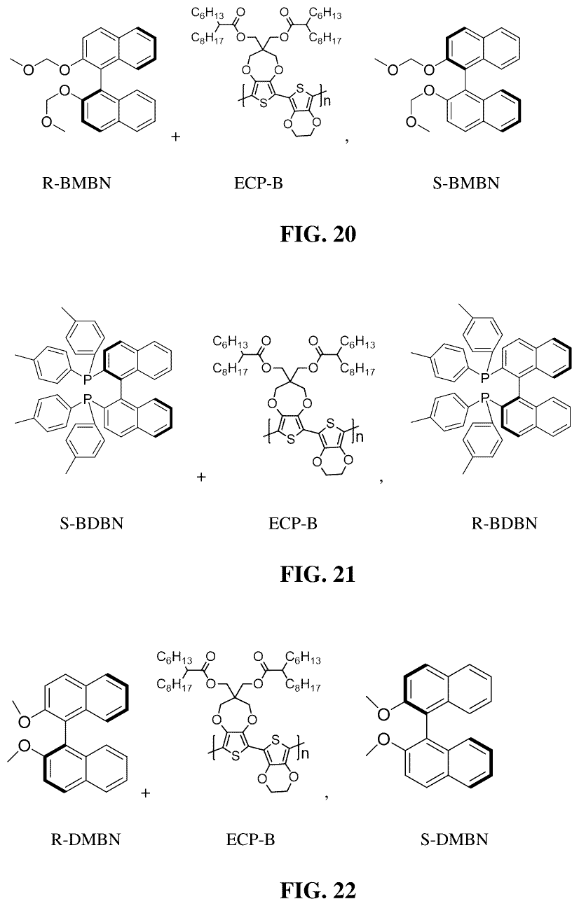

Chiral-3 is prepared by a chiral templating method by mixing the chiral additive R-BMBN and the achiral polymer ECP-B shown in FIG. 20. As shown in FIG. 10, Chiral-3 is dissymmetric with a high CD signal in the neutral state and its CD signal decreases slightly after thermal annealing at 250° C. S-BMBN can also be used as a chiral template with ECP-B.

### Embodiment 4—Chiral-4

Chiral-4 is prepared by a chiral templating method by mixing the chiral additive S-BDBN and the achiral polymer ECP-B shown in FIG. 21. As shown in FIG. 11, Chiral-4 is dissymmetric with a high CD signal in the neutral state and its CD signal decreases slightly after thermal annealing at 250° C. R-BDBN can also be used as a chiral template with ECP-B.

### Embodiment 5—Chiral-5

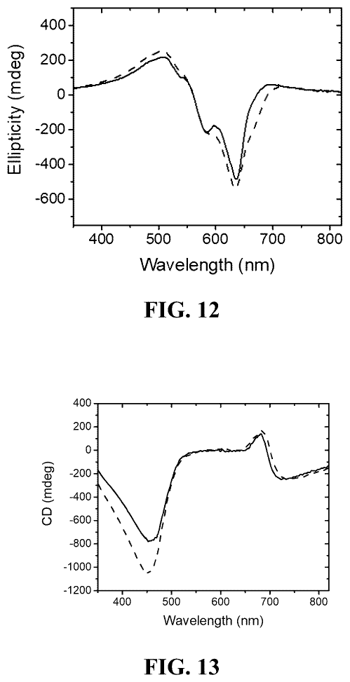

Chiral-5 is prepared by a chiral templating method by mixing the chiral additive R-DMBN and the achiral polymer ECP-B shown in FIG. 22. As shown in FIG. 12, Chiral-5 is dissymmetric with a high CD signal in the neutral state and its CD signal increases slightly after thermal annealing at 250° C. S-DMBN can also be used as a chiral template with ECP-B.

### Embodiment 6—Chiral-6

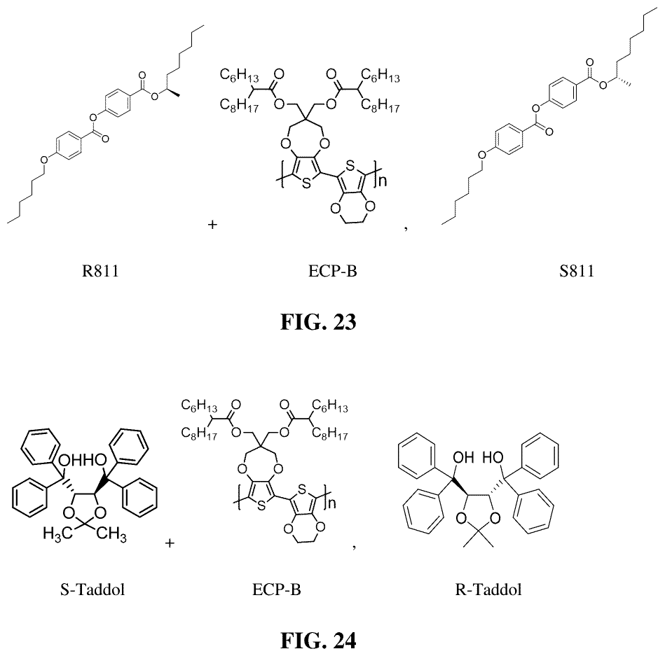

Chiral-6 is prepared by a chiral templating method by mixing the chiral additive R811 and the achiral polymer ECP-B shown in FIG. 23. As shown in FIG. 13, Chiral-6 is dissymmetric with a high CD signal in the neutral state and its CD signal increases after thermal annealing at 250° C. S811 can also be used as a chiral template with ECP-B.

### Embodiment 7—Chiral-7

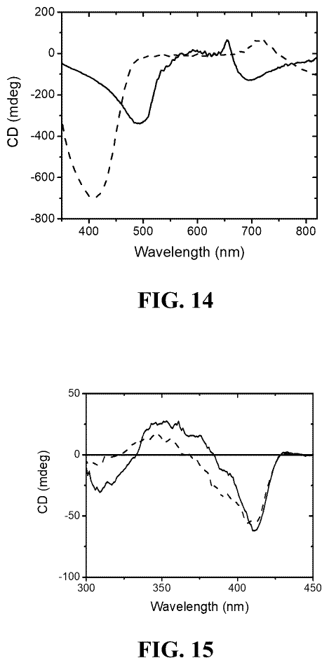

Chiral-7 is prepared by a chiral templating method by mixing the chiral additive S-Taddol and the achiral polymer ECP-B shown in FIG. 24. As shown in FIG. 14, Chiral-7 is dissymmetric with a high CD signal in the neutral state and its CD signal increases after thermal annealing at 250° C. R-Taddol can also be used as a chiral template with ECP-B.

### Embodiment 8—Chiral-8

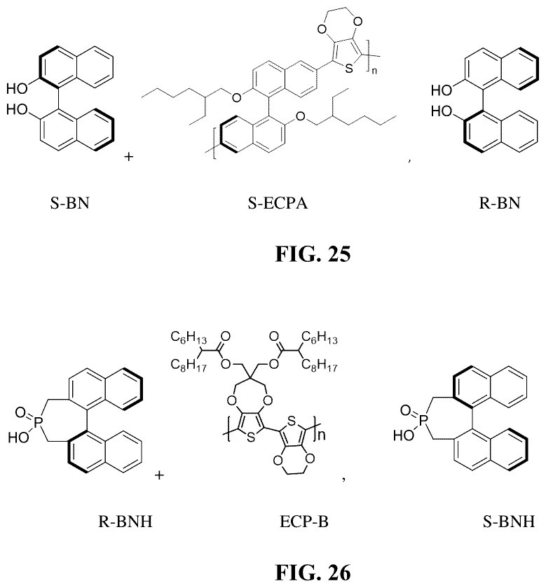

Chiral-8 is prepared by a chiral templating method by mixing the chiral additive S-BN and the chiral polymer S-ECPA shown in FIG. 25. S-ECPA has a small CD signal of about 10 mdeg without the chiral additive. As shown in FIG. 15, after the interaction with S-BN, the CD signal for Chiral-8 is amplified to around 60 mdeg in the neutral state and decreases slightly after thermal annealing at 250° C. R-BN can also be used as a chiral template with S-ECPA.

### Embodiment 9—Chiral-9

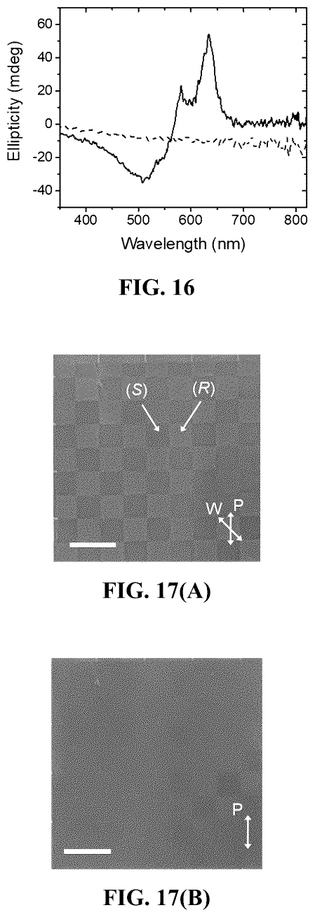

Chiral-9 is prepared by a chiral templating method by mixing the chiral additive R-BNH and the achiral polymer ECP-B shown in FIG. 26. As shown in FIG. 16, Chiral-9 is dissymmetric with a CD signal in the neutral state and its CD signal is lost after thermal annealing at 250° C., so Chiral-9 without thermal annealing is used for a chiral ECD. S-BNH can be also used as a chiral template with ECP-B.

To fabricate an example chiral EC device, a standard configuration ITO/counter electrode (CE)/Electrolyte/ECP (electrochromic polymer)/ITO (indium tin oxide) is used for the assembly, where VOₓ serves as the charge-balancing material (CE), the electrolyte is made from polyethylene glycol diacrylate (PEGDA):lithium bis(trifluoromethanesulfonyl)imide (LiTFSI), and the EC layer is chiral EC templated by chiral additive.

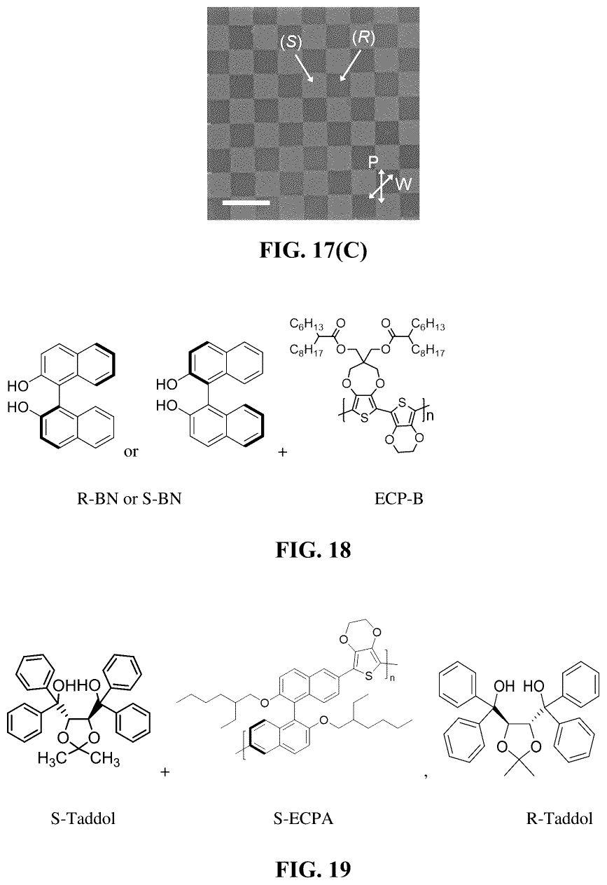

In an example disclosed patterned ECD, an R-BN templated Chiral-1 polymer film is grid-patterned using conventional photolithography in combination with dry reactive ion etching (RIE) process and the other configuration is similar as an example chiral EC device described above. As shown in FIGS. 17(A)-(C), the images measured at −45° (left) and +45° (right) cross angles demonstrate distinct differential colors in the grid-patterned chiral films, depending on matching between the polarization handedness of the filters and the chiral composition of the films. Consequently, the two images from a single segment display can be separated to enter the left and right human eyes after passing through opposite circular polarization lenses, resulting in binocular disparity and an immersive 3D sensation for viewers.

A more sophisticated example segment-type EC display is prepared by patterning chiral ECP-Blue films, which can be colored and bleached by the external electric bias (−1.0 V for colored and +1.0 V for bleached state). The photographic results after circular polarization filtering reveal differential colors with low crosstalk observed at the positions of the left and right human eyes, even in micro-sized patterns. Furthermore, the circular polarization-encoded images can be hidden from native eye as demonstrated through using linear polarization filtering (i.e., zero cross angle between waveplate and linear polarizer), which showcase a successful proof-of-concept for information encryption and anti-counterfeit concepts using circular polarization encoding.

What is claimed is:

1. A circularly polarized electrochromic device, comprising a first substrate and a cell disposed on the first substrate,
wherein the cell comprises:
a first electrode;
a chiral electrochromic layer disposed on the first electrode, wherein the chiral electrochromic layer presents differential color changes depending upon handedness of circularly polarized light under an applied voltage, and the chiral electrochromic layer presents at least one of differential transmittance and differential absorbance depending upon the handedness of circularly polarized light under the applied voltage;
an electrolyte layer disposed on the chiral electrochromic layer;
an ion storage layer disposed on the electrolyte layer; and
a second electrode disposed on the ion storage layer.

2. The circularly polarized electrochromic device of claim 1, wherein the chiral electrochromic layer comprises one or more chiral electrochromic molecules selected from a group including chiral organic electrochromic compounds, chiral electrochromic polymers, and chiral electrochromic liquid crystals.

3. The circularly polarized electrochromic device of claim 2, wherein the chiral electrochromic layer further comprises a chiral additive.

4. The circularly polarized electrochromic device of claim 1, wherein the chiral electrochromic layer comprises one or more blended systems comprising one or more molecules mixed with a chiral additive, wherein the one or more molecules are selected from organic compounds, conjugated polymers, and liquid crystals, wherein at least one of the one or more molecules and the chiral additive is electrochromic, and the one or more molecules are chiral.

5. The circularly polarized electrochromic device of claim 4, wherein the chiral additive comprises one or more selected from a group including chiral organic compounds, chiral polymers, chiral liquid crystals, and chiral nanoparticles.

6. The circularly polarized electrochromic device of claim 5, wherein the chiral additive comprises one or more selected from a group including chiral organic compounds, chiral polymers, chiral liquid crystals, and chiral nanoparticles.

7. The circularly polarized electrochromic device of claim 1, further comprising a second substrate.

8. The circularly polarized electrochromic device of claim 1, wherein the electrolyte layer comprises a solid electrolyte, a liquid electrolyte, or a gel electrolyte.

9. The circularly polarized electrochromic device of claim 7, wherein at least one of the first substrate and the second substrate is flexible.

10. The circularly polarized electrochromic device of claim 1, wherein at least one of the first electrode and the second electrode is transparent or semi-transparent.

11. The circularly polarized electrochromic device of claim 1, wherein both of the first electrode and the second electrode are transparent or semi-transparent.

12. The circularly polarized electrochromic device of claim 1, wherein the first electrode or the second electrode comprises a reflective conducting layer.

13. The circularly polarized electrochromic device of claim 1, wherein the ion storage layer includes one or more oxides of metal elements in Group 4-12, or a mixture of the oxides, or one of the oxides doped by another metal oxide or a redox-active conjugated polymer or a redox-active organic compound.

14. A circularly polarized electrochromic device, comprising two substrates and a plurality of areas disposed between the two substrates, wherein each of the areas comprises:
a first electrode;
a chiral electrochromic layer disposed on the first electrode, wherein the chiral electrochromic layer presents differential color changes depending upon handedness of circularly polarized light under an applied voltage, and the chiral electrochromic layer presents at least one of differential transmittance and differential absorbance depending upon the handedness of circularly polarized light under the applied voltage;
an electrolyte layer disposed on the chiral electrochromic layer;
an ion storage layer disposed on the electrolyte layer; and
a second electrode disposed on the ion storage layer.

15. The circularly polarized electrochromic device of claim 14, wherein the chiral electrochromic layer comprises one or more chiral electrochromic molecules selected from a group including chiral organic electrochromic compounds, chiral electrochromic polymers, and chiral electrochromic liquid crystals.

16. The circularly polarized electrochromic device of claim 15, wherein the chiral electrochromic layer further comprises a chiral additive.

17. The circularly polarized electrochromic device of claim 14, wherein the chiral electrochromic layer comprises one or more blended systems comprising one or more molecules mixed with a chiral additive, wherein the one or more molecules are selected from organic compounds, conjugated polymers, and liquid crystals, wherein at least one of the one or more molecules and the chiral additive is electrochromic, and the one or more molecules are chiral.

18. The circularly polarized electrochromic device of claim 16, wherein the chiral additive comprises one or more selected from a group including chiral organic compounds, chiral polymers, chiral liquid crystals, and chiral nanoparticles.

19. The circularly polarized electrochromic device of claim 17, wherein the chiral additive comprises one or more selected from a group including chiral organic compounds, chiral polymers, chiral liquid crystals, and chiral nanoparticles.
